(19) United States
(12) Patent Application Publication
(10) Pub. No.: US 2024/0126452 A1
(43) Pub. Date: Apr. 18, 2024

(54) STORAGE DEVICE AND OPERATING METHOD OF CONTROLLER

(71) Applicant: SK hynix Inc., Icheon-si Gyeonggi-do (KR)

(72) Inventors: Do Hyun LEE, Icheon-si Gyeonggi-do (KR); Tae Hoon KIM, Icheon-si Gyeonggi-do (KR)

(73) Assignee: SK hynix Inc., Icheon-si Gyeonggi-do (KR)

(21) Appl. No.: 18/184,547

(22) Filed: Mar. 15, 2023

(30) Foreign Application Priority Data
Oct. 13, 2022 (KR) 10-2022-0131587

(51) Int. Cl. G06F 3/06

(52) U.S. Cl. CPC G06F 3/0619; G06F 3/064; G06F 3/0659; G06F 3/0673

(57) ABSTRACT

A storage device includes a memory device including a memory block including memory regions, and a controller configured to store read results of read operations by performing the read operations on the memory regions, to determine first reference values of the memory regions, respectively, based on the read results, to determine a second reference value of the memory block based on the first reference values, and to determine whether the memory block is a potential bad block based on the second reference value. Each of the read results is the number of error bits that are included in data that has been read from the memory region in a corresponding read operation, each of the first reference values is the smallest value among the read results of a plurality of read operations for a corresponding memory region, and the second reference value is the greatest value among the first reference values.

### CROSS-REFERENCES TO RELATED APPLICATION

The present application claims priority under 35 U.S.C. § 119(e) to Korean application number 10-2022-0131587, filed on Oct. 13, 2022, in the Korean Intellectual Property Office, which is incorporated herein by reference in its entirety.

### BACKGROUND

### 1. Technical Field

The present technology relates to a storage device including a memory device.

### 2. Related Art

A storage device may be configured to store data that is provided by an external device in response to a write request from the external device. Furthermore, the storage device may be configured to provide the external device with data that has been stored in the storage device in response to a read request from the external device. The external device is an electronic device capable of processing data, and may include a computer, a digital camera, and a mobile phone. The storage device may operate by being embedded in the external device or may operate by being fabricated in a separable form and connected to the external device. The storage device may include a memory device for storing data.

The memory device may include a plurality of memory blocks. The memory block may be a unit by which the memory device performs an erase operation, for example. The storage device may detect a bad block in the memory device, and may restrict the use of the bad block.

### SUMMARY

A storage device according to an embodiment may include: a memory device including a memory block including memory regions, and a controller configured to store read results of read operations by performing the read operations on the memory regions, to determine first reference values of the memory regions, respectively, based on the read results, to determine a second reference value of the memory block based on the first reference values, and to determine whether the memory block is a potential bad block based on the second reference value. Each of the read results may be the number of error bits that are included in data that has been read from the memory region in a corresponding read operation. Each of the first reference values may be the smallest value among the read results of a plurality of read operations for a corresponding memory region. The second reference value may be the greatest value among the first reference values.

An operating method of a controller of a storage device according to an embodiment may include: storing read results of read operations performed on memory regions that are included in a memory block, wherein each of the read results is the number of error bits that is included in data that has been read from a memory region in a corresponding read operation; determining first reference values of the memory regions, respectively, based on the read results, wherein each of the first reference values is the smallest value among read results of a plurality of read operations for a corresponding memory region; determining a second reference value of the memory block based on the first reference values, wherein the second reference value is the greatest value among the first reference values; and determining whether the memory block is a potential bad block based on the second reference value.

### BRIEF DESCRIPTION OF THE DRAWINGS

FIG. 1 is a block diagram illustrating a storage device 100 according to an embodiment.

FIG. 2 is a diagram illustrating a construction of any one memory block MB1 in FIG. 1 according to an embodiment.

FIG. 3 is a diagram for describing distributions D0 to D3 of threshold voltages of memory cells.

FIG. 4 is a diagram illustrating read voltage sets according to an embodiment.

FIG. 5 is a table for describing a method of determining, by a controller 120 in FIG. 1, a potential bad block according to an embodiment.

FIG. 6 is a flowchart illustrating an operating method of the controller 120 in FIG. 1 according to an embodiment.

### DETAILED DESCRIPTION

Hereinafter, embodiments of the present technology will be described in detail with reference to the accompanying drawings.

Various embodiments are directed to a storage device and an operating method of a controller, which can effectively detect a potential bad block.

The storage device and the operating method of the controller according to embodiments can effectively detect a potential bad block.

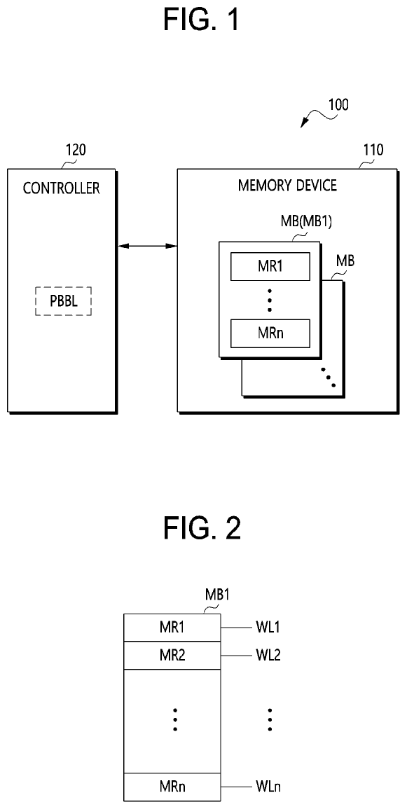

FIG. 1 is a block diagram illustrating a storage device 100 according to an embodiment.

The storage device 100 may be configured to store data that has been received from an external device, in response to a write request from the external device. Furthermore, the storage device 100 may be configured to provide the external device with data that has been stored in the storage device, in response to a read request from the external device.

The storage device 100 may include, for example, a personal computer memory card international association (PCMCIA) card, a smart media card, a memory stick, various multimedia cards (e.g., an MMC, an eMMC, an RS-MMC, and an MMC-micro), secure digital (SD) cards (e.g., SD, mini-SD, and micro-SD), universal flash storage (UFS), or a solid state drive (SSD).

The storage device 100 may include a memory device 110 and a controller 120.

The memory device 110 may operate under the control of the controller 120. An operation of the memory device 110 may include a read operation, a write operation (in other words, a program operation), and an erase operation.

The memory device 110 may include a plurality of memory blocks MB. Each of the memory blocks MB may include a plurality of memory regions MR1 to MRn. Although not illustrated, each of the memory regions MR1 to MRn may include a plurality of memory cells that has been connected to the same word line.

The memory device 110 may be implemented as various types of memory, such as NAND flash memory, 3D NAND flash memory, NOR flash memory, resistive random-access memory (RRAM), phase change memory (PRAM), magnetoresistive random-access memory (MRAM), ferroelectric random-access memory (FRAM), and spin transfer torque random-access memory (SU-RAM).

The controller 120 may control an overall operation of the storage device 100. The controller 120 may control the memory device 110 in response to a request from the external device. For example, the controller 120 may write data in the memory device 110 in response to a write request from the external device, and may read data from the memory device 110 in response to a read request from the external device. In an embodiment, the controller 120 may be implemented as hardware like an electronic circuit, software, firmware, or a combination thereof.

Furthermore, the controller 120 may control the memory device 110 to perform a management operation that is internally required, independently of the external device, that is, although the controller 120 does not receive a request from the external device. For example, the management operation may include at least one of a wear labeling operation, a garbage collection operation, an erase operation, and a read reclaim operation. The management operation may include an operation of writing data in the memory device 110 and reading data from the memory device 110. According to an embodiment, the management operation may be performed by a request from the external device.

The controller 120 may store read results by performing read operations on the memory regions MR1 to MRn that have been included in a memory block MB1, may determine each of first reference values of the memory regions MR1 to MRn based on each of the read results, may determine a second reference value of the memory block MB1 based on the first reference values, and may determine whether the memory block MB1 is a potential bad block based on the second reference value. In this case, each of the read results may be the number of error bits that is included in data that has been read from the memory region MR in a corresponding read operation. Each of the first reference values may be the smallest value, among the read results of a plurality of read operations for a corresponding memory region MR. The second reference value may be the greatest value, among the first reference values.

Accordingly, the controller may manage a potential bad block list PBBL that includes information on one or more potential bad blocks, and may use potential bad blocks while more carefully monitoring the potential bad blocks than normal memory blocks MB. For example, when error bits having a predetermined threshold value or more occur in a read operation for a potential bad block again, the controller may determine the potential bad block as a definite bad block, and might not use the potential bad block. Accordingly, a loss of data attributable to the occurrence of a bad block can be effectively prevented.

According to an embodiment, the controller may perform a plurality of read operations on each memory region MR by using different read voltage sets.

According to an embodiment, the controller may determine the memory block MB1 as a potential bad block when a second reference value is greater than a threshold value.

According to an embodiment, the controller may determine each of second reference values of the plurality of memory blocks MB that have been included in the memory device, and may determine a threshold value based on a standard deviation (SD) of the second reference values. According to an embodiment, the controller may determine, as the threshold value, a value that is obtained by adding three times the standard deviation (3*SD) to an average of the second reference values of the plurality of memory blocks MB. According to an embodiment, the controller may use a threshold value that has been predetermined through tests in its manufacturing step.

FIG. 2 is a diagram illustrating a construction of any one memory block MB1 in FIG. 1 according to an embodiment.

Referring to FIG. 2, the memory block MB1 may include a plurality of memory regions MR1 to MRn. The memory regions MR1 to MRn may be connected to different word lines WL1 to WLn. Each of the memory regions MR1 to MRn may include a plurality of memory cells (not illustrated) that have been connected to a corresponding word line. The memory device 110 may access a memory region that has been connected to a selected word line, by selecting any one of the word lines.

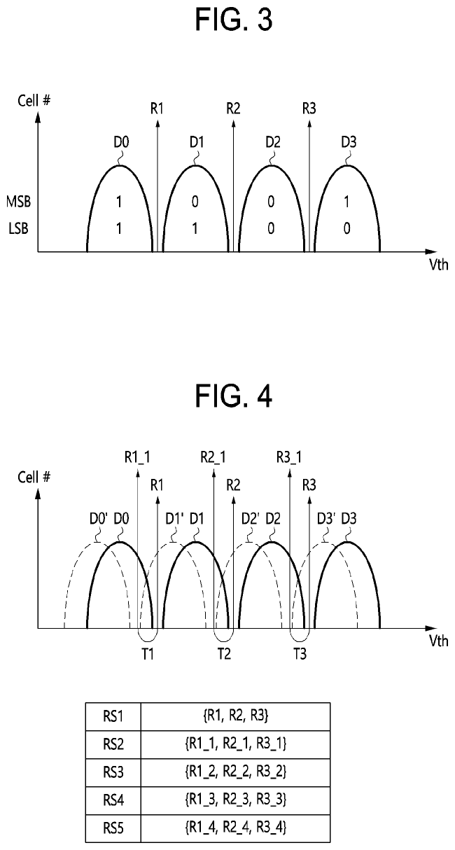

FIG. 3 is a diagram for describing distributions D0 to D3 of threshold voltages of memory cells. A transverse axis Vth may mean threshold voltages of memory cells. A longitudinal axis Cell #may mean the number of memory cells that have corresponding threshold voltages.

Referring to FIG. 3, the memory cells may be multi-level cells (MLCs) in each of which two bits per memory cell, that is, the least significant bit (LSB) and the most significant bit (MSB), are stored, for example. In this case, the memory cells may form the distributions DO to D3 of threshold voltages based on data that has been stored in the memory cells. The memory cells that form the distributions D0 to D3 of threshold voltages may be memory cells that are included in one of the memory regions MR1 to MRn in FIG. 2, for example. In a write operation, each memory cell may be controlled to form any one of the four distributions D0 to D3 of threshold voltages based on 2-bit data that will be stored in each memory cell. For example, a memory cell in which data 11 has been stored may form the distribution D0 of threshold voltages. According to an embodiment, when k bits per memory cell are stored, the memory cells may form 2\hat{ }k distributions of threshold voltages.

When k bits per memory cell are stored, one memory region that is constructed by memory cells may logically include k sub-regions, in other words, pages. For example, when a memory cell is an MLC, each memory region may logically include two pages, that is, an LSB page (or a page at the lowest level) in which the LSB is stored and an MSB page (or a page at the highest level) in which the MSB is stored.

A memory cell may be turned on/off based on its threshold voltage, when a read voltage is applied through a word line that has been connected to the memory cell. Specifically, the memory cell may be turned on when a read voltage higher than its threshold voltage is applied, and may be turned off when a read voltage lower than its threshold voltage is applied. The memory cell may induce different currents when being turned on and turned off. The memory device 110 may determine whether the threshold voltage of the memory cell is higher or lower than the read voltage by sensing such currents. Accordingly, when each of read voltages R1 to R3 that are disposed between (or at the valleys of) the distributions D0 to D3 of threshold voltages is applied to the memory cell, the memory device 110 may determine whether the threshold voltage of the memory cell is higher or lower than each of the read voltages R1 to R3. As a result, the memory device 110 may determine a distribution of threshold voltages that are formed by memory cells by using the read voltages R1 to R3, and may read data that has been stored in the memory cells.

For example, the LSB data that has been stored in the LSB page may be read by using the read voltages R2. That is, when a memory cell has a threshold voltage lower than the read voltage R2, 1 may be read from the memory cell as the LSB data. Furthermore, when the memory cell has a threshold voltage higher than the read voltage R2, 0 may be read from the memory cell as the LSB. According to a similar principle, the MSB data that has been stored in the MSB page may be read by using the read voltages R1 and R3.

FIG. 4 is a diagram illustrating read voltage sets according to an embodiment.

Referring to FIG. 4, the controller may perform a read operation by using the first to fifth read voltage sets RS1 to RS5. The number of read voltage sets RS1 to RS5, that is, 5, may be an example. A first read voltage set RS1 may consist of the read voltages R1 to R3 in FIG. 3, for example. Each of the first to fifth read voltage sets RS1 to RS5 may consist of voltages each different from each of the read voltages R1 to R3 by a predetermined adjustment value. For example, read voltages R1_1 to R3_1 that form the second read voltage set RS2 may be lower than the read voltages R1 to R3 by adjustment values T1 to T3, respectively. The adjustment values T1 to T3 may be the same or different from each other.

The memory regions MR1 to MRn might not form the same distribution of threshold voltages due to physical characteristics from the start of their manufacturing. Furthermore, as memory cells are aged, the memory regions MR1 to MRn might not form the same distribution of threshold voltages. For example, in the situation in which the memory cells of the first memory region MR1 may form the distributions D0 to D3 of threshold voltages, the memory cells of the second memory region MR2 may form distributions DO′ to D3′ of threshold voltages.

The controller 120 might not know which read voltages are located at the valleys of distributions of threshold voltages because the controller 120 does not accurately know the distributions of threshold voltages that have been formed by memory cells in the ordinary case. Accordingly, the controller 120 may read different data from a memory region by using the first to fifth read voltage sets RS1 to RS5 that are different from each other, and may select the most suitable read voltage set from the first to fifth read voltage sets RS1 to RS5 based on corresponding data in order to continuously use the most suitable read voltage set in the corresponding memory region. More specifically, the most suitable read voltage set may be a read voltage set including the smallest number of error bits, which have been read from the corresponding memory region.

The first to fifth read voltage sets RS1 to RS5 may be predetermined and stored in the controller. According to an embodiment, the controller may adjust the first to fifth read voltage sets RS1 to RS5 while operating.

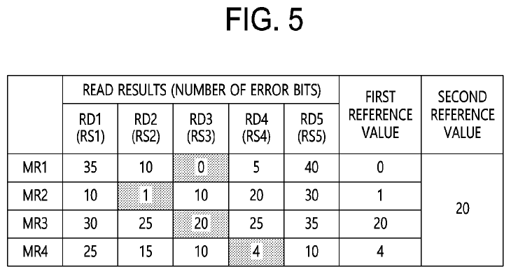

FIG. 5 is a diagram for describing a method of determining, by the controller 120 in FIG. 1, a potential bad block according to an embodiment.

Referring to FIG. 5, the controller 120 may perform first to fifth read operations on each of the first to fourth memory regions MR1 to MR4 that are included in the memory block MB1 by using the first to fifth read voltage sets RS1 to RS5. The first to fourth memory regions MR1 to MR4 may be at least some of the memory regions that are included in the memory block MB1. The controller 120 may store first to fifth read results RD1 to RD5 of the first to fifth read operations in each of the first to fourth memory regions MR1 to MR4. Each of the first to fifth read results RD1 to RD5 may be the number of error bits that are included in data that has been read from a corresponding memory region by using a corresponding read voltage set. The data that has been read from each memory region may be data that has been read from at least one page of each memory region.

According to an embodiment, the controller 120 may determine the number of error bits that has been included in read data, by storing predetermined test data in the first to fourth memory regions MR1 to MR4 and comparing the read data with the test data. According to an embodiment, the controller 120 may determine the number of error bits that have been included in read data, by performing an ECC operation on the read data and comparing read data before the ECC operation is performed and read data after the ECC operation is performed.

The controller 120 may determine first reference values of the first to fourth memory regions MR1 to MR4, respectively. Each of the first reference values of the first to fourth memory regions MR1 to MR4 may be the smallest value, among the first to fifth read results RD1 to RD5 of each memory region. That is, the first reference values may mean the results of the execution of the best read operations for the first to fourth memory regions MR1 to MR4 which may form different distributions of threshold voltages.

Furthermore, the controller 120 may determine a second reference value of the memory block MB1. The second reference value of the memory block MB1 may be the greatest value, among the first reference values of the first to fourth memory regions MR1 to MR4. The controller 120 may determine the memory block MB1 as a potential bad block when the second reference value is greater than a threshold value. That is, if the worst case, among the results of the execution of the best read operations, has an unacceptable level although the best read operations have been performed on the first to fourth memory regions MR1 to MR4, the controller 120 may determine the memory block MB1 as a potential bad block. Through such a determination method, a potential bad block can be effectively detected according to a very reasonable and clear standard.

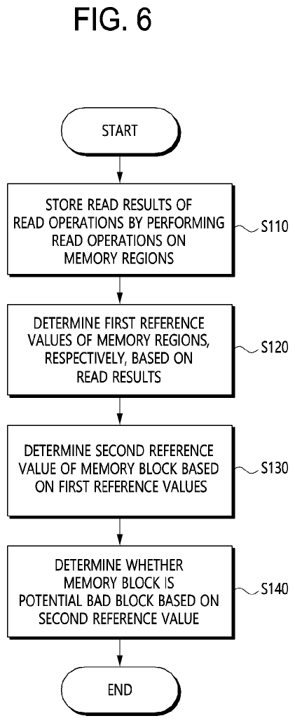

FIG. 6 is a flowchart illustrating an operating method of the controller 120 in FIG. 1 according to an embodiment.

Referring to FIG. 6, in step S110, the controller 120 may store read results of read operations by performing the read operations on the memory regions MR1 to MRn that have been included in the memory block MB1. Each of the read results may be the number of error bits that is included in data that has been read from the memory region MR in a corresponding read operation.

In step S120, the controller 120 may determine first reference values of the memory regions MR1 to MRn, respectively, based on the read results. Each of the first reference values may be the smallest value, among the read results of a plurality of read operations for a corresponding memory region MR.

In step S130, the controller 120 may determine a second reference value of the memory block MB1 based on the first reference values. The second reference value may be the greatest value, among the first reference values.

In step S140, the controller 120 may determine whether the memory block MB1 is a potential bad block based on the second reference value. For example, the controller 120 may determine the memory block MB1 as a potential bad block when the second reference value is greater than a threshold value.

The above description is merely a description of the technical spirit of the present disclosure, and those skilled in the art may change and modify the present disclosure in various ways without departing from the essential characteristic of the present disclosure. Furthermore, the embodiments described in the present disclosure should not be construed as limiting the technical spirit of the present disclosure, but should be construed as describing the technical spirit of the present disclosure. The technical spirit of the present disclosure is not restricted by the embodiments. The range of protection of the present disclosure should be construed based on the following claims, and all of technical spirits within an equivalent range of the present disclosure should be construed as being included in the scope of rights of the present disclosure.

What is claimed is:

1. A storage device comprising:
a memory device comprising a memory block comprising memory regions; and
a controller configured to store read results of read operations by performing the read operations on the memory regions, to determine first reference values of the memory regions, respectively, based on the read results, to determine a second reference value of the memory block based on the first reference values, and to determine whether the memory block is a potential bad block based on the second reference value,
wherein each of the read results is a number of error bits that are included in data that has been read from the memory region in a corresponding read operation, each of the first reference values is a smallest value among read results of a plurality of read operations for a corresponding memory region, and the second reference value is a greatest value among the first reference values.

2. The storage device according to claim 1, wherein the controller is configured to perform the plurality of read operations on the corresponding memory region by using different read voltage sets.

3. The storage device according to claim 1, wherein the controller is configured to determine the memory block as a potential bad block when the second reference value is greater than a threshold value.

4. The storage device according to claim 3, wherein the controller is configured to:
determine second reference values of a plurality of memory blocks that are included in the memory device, respectively, and
determine the threshold value based on a standard deviation of the second reference values.

5. The storage device according to claim 1, wherein the controller is configured to store test data in the memory regions before performing the read operations.

6. The storage device according to claim 1, wherein the memory regions are connected to different word lines.

7. An operating method of a controller of a storage device, comprising:
storing read results of read operations performed on memory regions that are included in a memory block, wherein each of the read results is a number of error bits that is included in data that has been read from a memory region in a corresponding read operation;
determining first reference values of the memory regions, respectively, based on the read results, wherein each of the first reference values is a smallest value among read results of a plurality of read operations for a corresponding memory region;
determining a second reference value of the memory block based on the first reference values, wherein the second reference value is a greatest value among the first reference values; and
determining whether the memory block is a potential bad block based on the second reference value.

8. The operating method according to claim 7, wherein the plurality of read operations for the corresponding memory region is performed by using different read voltage sets.

9. The operating method according to claim 7, wherein determining whether the memory block is a potential bad block comprises determining the memory block as a potential bad block when the second reference value is greater than a threshold value.

10. The operating method according to claim 9, further comprising:
determining second reference values of the plurality of memory blocks, respectively; and
determining the threshold value based on a standard deviation of the second reference values.

11. The operating method according to claim 7, further comprising storing test data in the memory regions before performing the read operations.

12. The operating method according to claim 7, wherein the memory regions are connected to different word lines.
